(19) United States
(12) Patent Application Publication
(10) Pub. No.: US 2026/0241992 A1
(43) Pub. Date: Aug. 20, 2026

(54) HIGHLY MANEUVERABLE VEHICLE

(71) Applicant: AZAK Inc., Denver, CO (US)

(72) Inventor: Benjamin Meager, Denver, CO (US)

(21) Appl. No.: 19/542,795

(22) Filed: Feb. 18, 2026

Related U.S. Application Data
(60) Provisional application No. 63/759,969, filed on Feb. 18, 2025.

(51) Int. Cl. B62D 11/04; B60K 1/02; B60K 7/00; B60K 17/356; B60L 15/20; B62D 6/02; B62D 7/04

(52) U.S. Cl. CPC B62D 11/04; B60K 1/02; B60K 7/0007; B60K 17/356; B60L 15/20; B62D 6/02; B62D 7/04; B60L 2240/461

(57) ABSTRACT

A vehicle and steering system for a vehicle are described. The vehicle is described to include a frame and a first set of wheels comprising a first wheel and a second wheel, wherein the first wheel and the second wheel are rotatable relative to the frame around a first rotational axis and a second rotational axis, respectively, and wherein the first wheel and the second wheel are coupled with a first translational member via a first coupling and a second coupling, respectively, that translates lateral motion of the first translational member into rotational motion of the first wheel and second wheel, respectively.

### CROSS-REFERENCE TO RELATED APPLICATION

The present application claims the benefit of and priority, under 35 U.S.C. § 119, to U.S. Provisional Application Serial No. 63/759,969, filed February 18, 2025, entitled “HIGHLY MANEUVERABLE VEHICLE,” the entire disclosure of which is hereby incorporated herein by reference, in its entirety, for all that it teaches and for all purposes.

### FIELD

The present disclosure relates generally to the field of vehicles. More specifically, it relates to vehicles with improved maneuverability.

### BACKGROUND

Vehicle steering systems have developed over the years. The most common type of steering on cars, small trucks, and Sports Utility Vehicles (SUVs) is the rack-and-pinion steering. The purpose of rack-and-pinion steering is to convert rotation motion of a steering wheel into the linear motion needed to turn wheels of the vehicle. Another type of commonly available steering is skid steering, which is normally found on tracked vehicles such as tractors, tanks, bulldozers, and other industrial equipment. As compared to rack-and-pinion steering, the skid steering synchronizes the rotation of the vehicle’s front and rear wheels. Steering with a skid steering system is accomplished by actuating the wheels on each side of the vehicle at a different rate or in a different direction, causing the wheels or tracks to slip (e.g., “skid”) on the ground. Skid steering facilitates vehicle maneuvering in tight spaces, but provides the risk of damaging the ground (e.g., due to the skidding of the wheels or tracks over the ground). Rack-and-pinion steering helps to avoid the undesirable ground damage, but does not provide the same level of maneuverability that skid steering provides.

### SUMMARY

Embodiments of the present disclosure aim to provide a steering system for a vehicle that overcomes the damage normally caused by skid steering systems, while providing better maneuverability than rack-and-pinion systems or other traditional vehicle steering system.

In some embodiments, a vehicle is provided that includes: a frame; a first set of wheels comprising a first wheel and a second wheel, wherein the first wheel and the second wheel are rotatable relative to the frame around a first rotational axis and a second rotational axis, respectively, and wherein the first wheel and the second wheel are coupled with a first translational member via a first coupling and a second coupling, respectively, that translates lateral motion of the first translational member into rotational motion of the first wheel and second wheel, respectively; and a second set of wheels comprising a third wheel and a fourth wheel.

According to another embodiment of the present disclosure, a steering system is provided that includes: a frame; and a first set of wheels comprising a first wheel and a second wheel, wherein the first wheel and the second wheel are rotatable relative to the frame around a first rotational axis and a second rotational axis, respectively, and wherein the first wheel and the second wheel are coupled with a first translational member via a first coupling and a second coupling, respectively, that translates lateral motion of the first translational member into rotational motion of the first wheel and second wheel, respectively.

### BRIEF DESCRIPTION OF THE DRAWINGS

The present disclosure is described in conjunction with the appended figures, which are not necessarily drawn to scale:

FIG. 1 is an isometric view of a vehicle in a first position in accordance with at least some embodiments of the present disclosure;

FIG. 2 is a top view of the vehicle depicted in FIG. 1;

FIG. 3 is an isometric view of a vehicle in a second position in accordance with at least some embodiments of the present disclosure;

FIG. 4 is an isometric view of a vehicle in a third position in accordance with at least some embodiments of the present disclosure;

FIG. 5 is an isometric view of a vehicle in a fourth position in accordance with at least some embodiments of the present disclosure;

FIG. 6 is an isometric view of a vehicle in a fifth position in accordance with at least some embodiments of the present disclosure;

FIG. 7A is a front view of a set of wheels in accordance with at least some embodiments of the present disclosure;

FIG. 7B is an isometric view of the set of wheels depicted in FIG. 7A;

FIG. 8A is a front view of a wheel in accordance with at least some embodiments of the present disclosure;

FIG. 8B is an isometric view of the wheel depicted in FIG. 8A;

FIG. 9 is a block diagram depicting components of a vehicle and system for controlling the vehicle in accordance with at least some embodiments of the present disclosure;

FIG. 10A is a top isometric view of another example of a vehicle in accordance with at least some embodiments of the present disclosure;

FIG. 10B is a bottom isometric view of the vehicle of FIG. 10A;

FIG. 10C is a bottom view of the vehicle of FIG. 10A;

FIG. 10D is a bottom view of the vehicle of FIG. 10A with both sets of wheels turned in a common direction;

FIG. 10E is a bottom view of the vehicle of FIG. 10A with sets of wheels turned in different directions;

FIG. 10F is a bottom view of the vehicle of FIG. 10A with only one set of wheels turned while the other set of wheels remains pointed straight;

FIG. 10G is another isometric view of the vehicle of FIG. 10A in accordance with at least some embodiments of the present disclosure;

FIG. 11A is a top isometric view of another example of a vehicle in accordance with at least some embodiments of the present disclosure;

FIG. 11B is a bottom isometric view of the vehicle of FIG. 11A in accordance with at least some embodiments of the present disclosure; and

FIG. 11C is bottom plan view of the vehicle of FIG. 11A in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. Various changes may be made in the function and arrangement of elements without departing from the spirit and scope of the appended claims.

Various examples are provided throughout the following disclosure. The disclosure of examples is in all cases intended to be non-limiting, including specifically when examples are identified with the terms or phrases identifying what follows to be an example, including the terms of phrases “for example,” “as one example,” “such as,” “by way of example,” and “e.g.”

In other words, the disclosure of one or more examples is not intended to limit the present disclosure to embodiments conforming to the disclosed example(s).

Embodiments of vehicles disclosed herein may include any number of features. While various examples of vehicles and methods of refueling vehicles will be described with particular features, it should be appreciated that the features depicted and described in connection with a particular vehicle may be used in another vehicle or refueling system without departing from the scope of the present disclosure. Further still, embodiments of the present disclosure contemplate that vehicle wheels or sets of wheels may be easily replaced by other wheels or sets of wheels. Thus, embodiments of the present disclosure contemplate that wheels of one type may be used to replace wheels of another type.

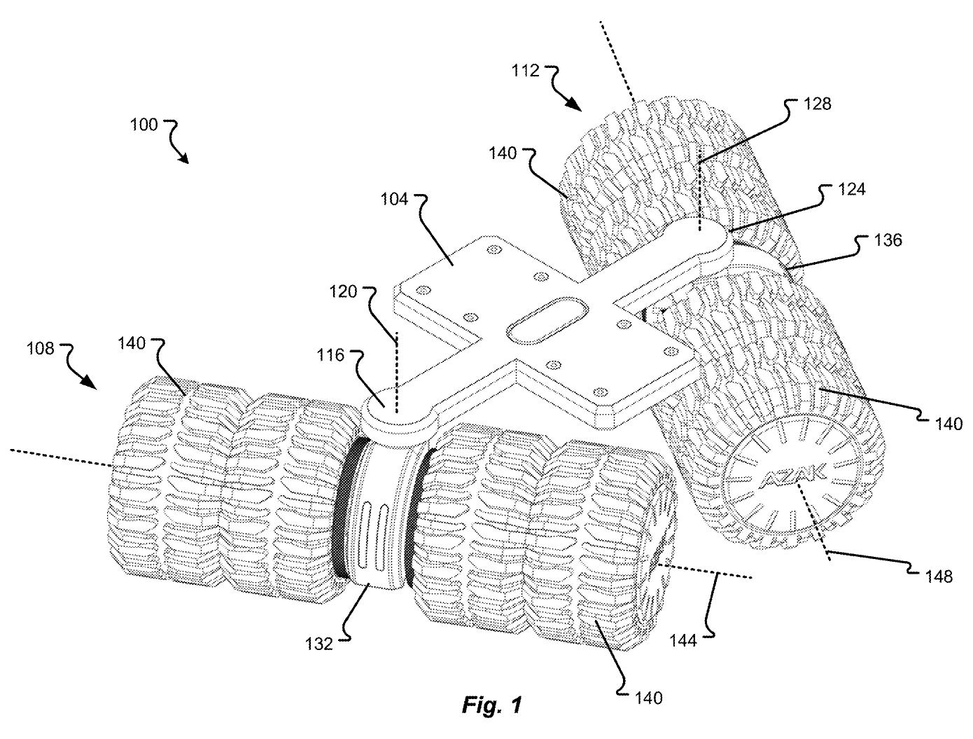

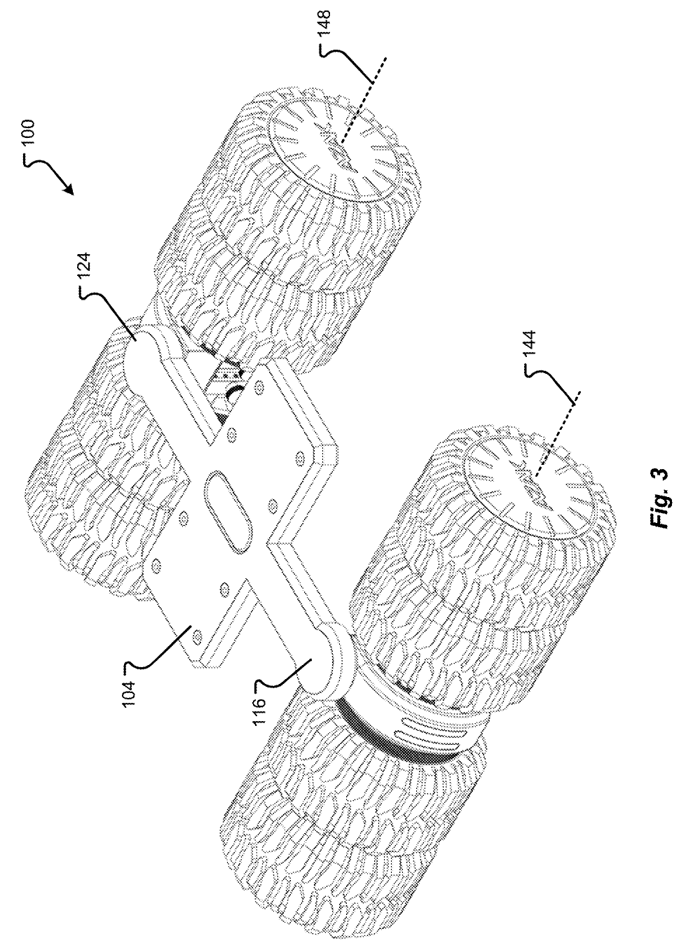

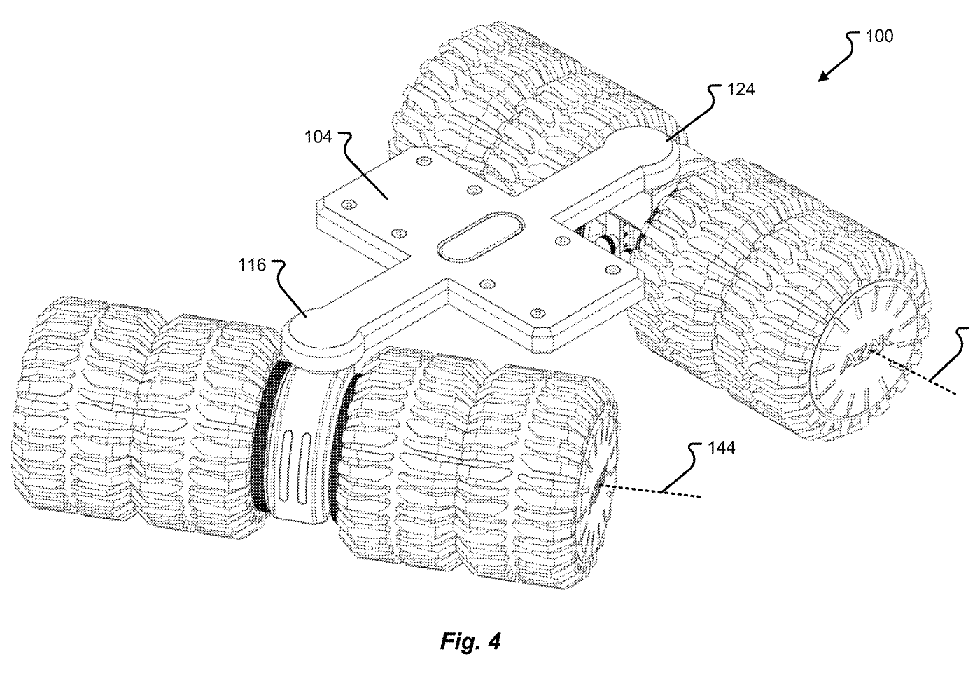

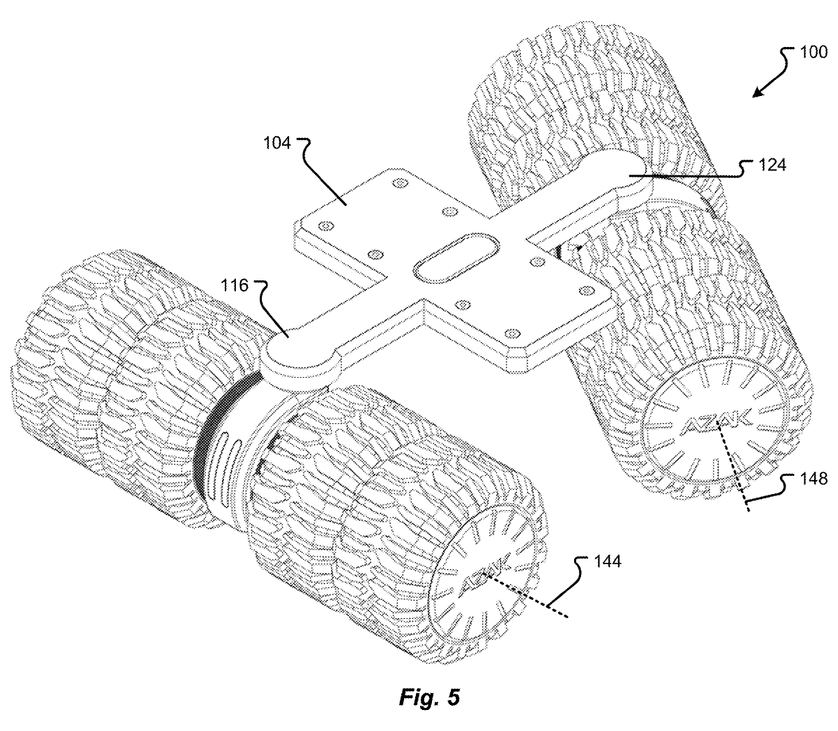

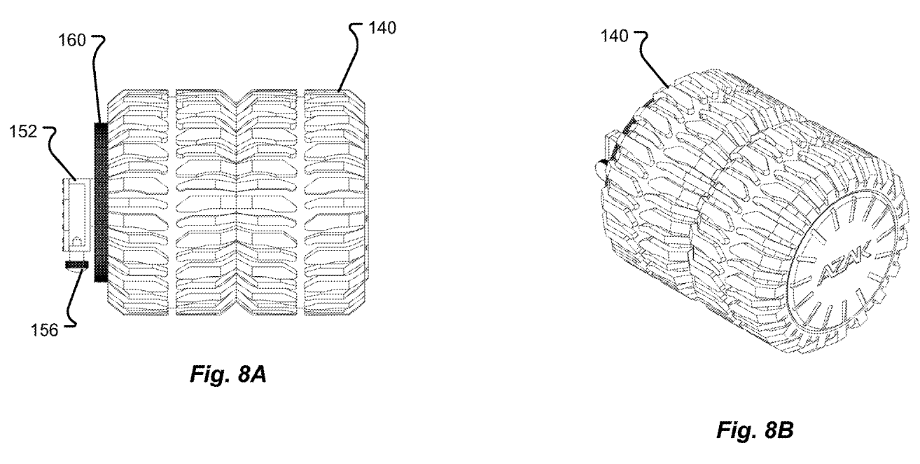

Referring now to FIGS. 1-8B, various details of a vehicle 100 and components thereof will be described in accordance with at least some embodiments of the present disclosure. The vehicle 100 is shown to include a frame 104 supported by a first set of wheels 108 and a second set of wheels 112. The first set of wheels 108 are mounted to the frame 104 via a first rotatable mount 132 and the second set of wheels 112 are mounted to the frame 108 via a second rotatable mount 136.

The first rotatable mount 132 may be connected to the frame 104 at a first frame end 116 and the second rotatable mount 136 may be connected to the frame 104 at a second frame end 124. The first frame end 116 may be located opposite the second frame end 124. The body of the frame 104 may correspond to the remaining portion of the frame 104 that resides between the first frame end 116 and the second frame end 124. In some embodiments, the frame 104 may be configured to support a load. For example, the frame 104 may be configured to support a payload that includes people, animal cargo, inanimate cargo, physical objects, liquid objects, etc.

In some embodiments, the vehicle 100 may be configured to operate autonomously, semi-autonomously, or under remote control by a human operator. Alternatively, the vehicle 100 can be operated by direct human control (e.g., as a driveable passenger vehicle in which the human is a passenger and controls the vehicle 100 while being carried by the vehicle 100). The vehicle 100 can be configured to operate in an industrial setting, in an agricultural setting, in a residential setting, or the like. Illustratively, but without limitation, the vehicle 100 can be configured to move around a distribution center or the like and may support objects that are being loaded or unloaded for order fulfillment.

As shown in FIG. 1, the first rotatable mount 132 may rotate about the first frame end 116 around a first steering axis 120. The second rotatable mount 136 may rotate about the second frame end 124 around a second steering axis 128. The first steering axis 120 and second steering axis 128 may be parallel with one another. In some embodiments, both the first steering axis 120 and the second steering axis 128 are perpendicular to ground and perpendicular to a top surface of the frame 104.

The first rotatable mount 132 may support the first set of wheels 108 and the second rotatable mount 136 may support the second set of wheels 112. The first set of wheels 108 may include a left wheel 140 and a right wheel 140. In some embodiments, the first set of wheels 108 may include more than two wheels 140. For example, the first set of wheels 108 may include two, three, four or more wheels 140. Similarly, the second set of wheels 112 may include a left wheel 140 and a right wheel 140. In some embodiments, the second set of wheels 112 may include more than two wheels 140. For example, the second set of wheels 112 may include two, three, four or more wheels 140.

Referring initially to the first set of wheels 108, the first rotatable mount 132 may have the left wheel 140 mounted directly thereto on its left side while the right wheel 140 is mounted directly to the first rotatable mount 132 on its right side. Both wheels 140 may be self-propelled, meaning that each wheel 140 includes an internal motor and motor controller. In some embodiments, the motor controllers of each wheel 140 may be coordinated together, either by a shared logic or by a centralized coordination that is delegated to one of the wheel’s 140 controllers. Each wheel 140 in the first set of wheels 108 may be configured to rotate about a first rotational axis 144. The first rotational axis 144 may bisect the first steering axis 120, although such a configuration is not required. In some embodiments, the first rotational axis 144 bisects the first steering axis 120. In some embodiments, the first rotational axis 144 is positioned in front of the first steering axis 120, meaning that the location where the first rotational axis 144 is nearest the first steering axis 120 is positioned away from the center of the frame 104 as compared to the first steering axis 120. In some embodiments, the first rotational axis 144 is positioned behind the first steering axis 120, meaning that the location where the first rotational axis 144 is nearest the first steering axis 120 is positioned closer to the center of the frame 104 as compared to the first steering axis 120.

Both (e.g., all) wheels 140 in the first set of wheels 108 may rotate about the first rotational axis 144 and pivot about the first steering axis 120. In some embodiments, movement of one wheel 140 (e.g., the left wheel 140) in the first set of wheels 108 about the first steering axis 120 is matched by a corresponding movement of the other wheel 140 (e.g., the right wheel 140) in the first set of wheels 108. It should be appreciated that each wheel 140 in the first set of wheels 108 may be driven independently meaning that one wheel 140 in the first set of wheels 108 may be driven forward while another wheel 140 in the first set of wheels 108 is driven backward or not driven at all. It may also be possible to drive each wheel 140 in the first set of wheels 108 at different speeds in the same direction or different directions (e.g., to induce turning of the first set of wheels 108 about the first steering axis 120).

Referring now to the second set of wheels 112, the second rotatable mount 136 may have the left wheel 140 mounted directly thereto on its left side while the right wheel 140 is mounted directly to the second rotatable mount 136 on its right side. Both wheels 140 may be self-propelled, meaning that each wheel 140 includes an internal motor and motor controller. In some embodiments, the motor controllers of each wheel 140 may be coordinated together, either by a shared logic or by a centralized coordination that is delegated to one of the wheel’s 140 controllers. Each wheel 140 in the second set of wheels 112 may be configured to rotate about a second rotational axis 148. The second rotational axis 148 may bisect the second steering axis 128, although such a configuration is not required. In some embodiments, the second rotational axis 148 bisects the second steering axis 128. In some embodiments, the second rotational axis 148 is positioned in front of the second steering axis 128, meaning that the location where the second rotational axis 148 is nearest the second steering axis 128 is positioned away from the center of the frame 104 as compared to the second steering axis 128. In some embodiments, the second rotational axis 148 is positioned behind the second steering axis 128, meaning that the location where the second rotational axis 148 is nearest the second steering axis 128 is positioned closer to the center of the frame 104 as compared to the second steering axis 128.

Both (e.g., all) wheels 140 in the second set of wheels 112 may rotate about the second rotational axis 148 and pivot about the second steering axis 128. In some embodiments, movement of one wheel 140 (e.g., the left wheel 140) in the second set of wheels 112 about the second steering axis 128 is matched by a corresponding movement of the other wheel 140 (e.g., the right wheel 140) in the second set of wheels 112. It should be appreciated that each wheel 140 in the second set of wheels 112 may be driven independently meaning that one wheel 140 in the second set of wheels 112 may be driven forward while another wheel 140 in the second set of wheels 112 is driven backward or not driven at all. It may also be possible to drive each wheel 140 in the second set of wheels 112 at different speeds in the same direction or different directions (e.g., to induce turning of the second set of wheels 112 about the second steering axis 128).

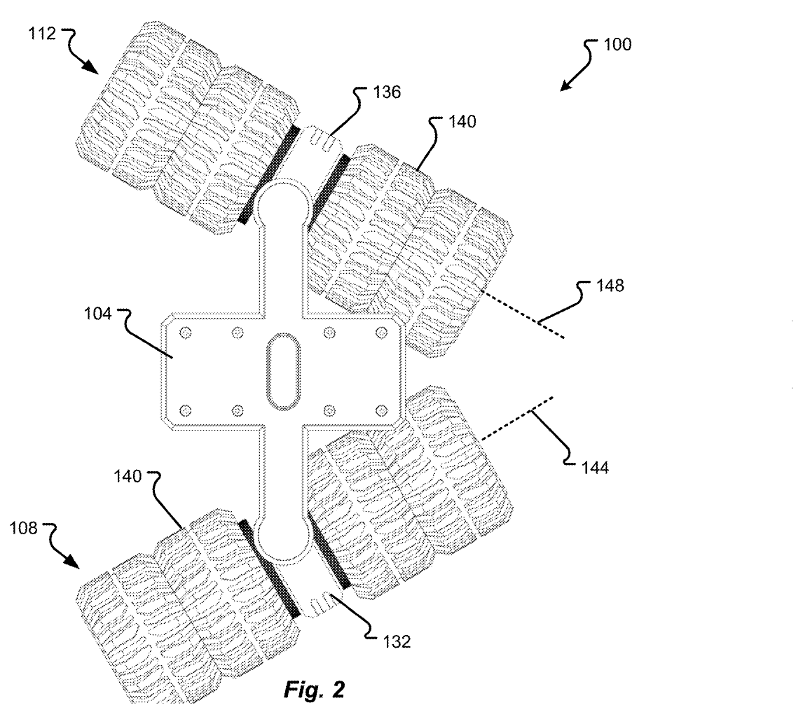

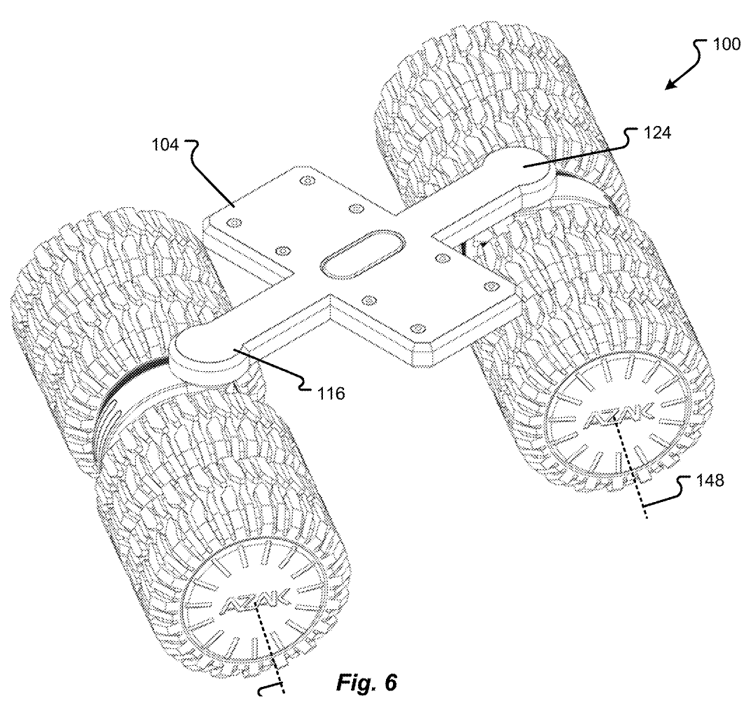

As can be seen in FIGS. 2-6, the first set of wheels 108 and second set of wheels 112 may be turned independent of one another about their respective steering axis. It may also be possible to coordinate steering of the first set of wheels 108 and second set of wheels 112 such that the vehicle 100 can be moved forward, laterally, or combinations thereof. An example of a steering configuration where the vehicle 100 can be moved laterally is shown in FIG. 6, where both the first set of wheels 108 and second set of wheels 112 are not pointed forward, but are both steered laterally with respect to the main axis of the frame 104. In other words, the vehicle 100 does not necessarily need to drive straight forwards or backwards. Additionally, because the wheels 140 in a set of wheels (either first set of wheels 108 or second set of wheels 112) rotate about a common steering axis (e.g., either first steering axis 120 or second steering axis 128), it may be possible to turn a set of wheels without invoking a skid/skipping as is known in traditional skid steering systems.

Specifically, as an example, the first set of wheels 108 may be rotated about the first steering axis 120 while the rest of the vehicle 100 (e.g., the frame 104 and the second set of wheels 112) remain stationary. This type of motion is made possible by having one of the wheels 140 in the first set of wheels 108 rotate in a first direction (e.g., forward) while the other wheel 140 in the first set of wheels 108 rotates in a second/opposite direction (e.g., backward) at the same speed as the wheel 140 rotating in the first direction. If the first rotational axis 144 is aligned with the first steering axis 120, then no skidding will be required to move the first set of wheels 112 even if the rest of the vehicle 100 remains stationary. Such a movement may facilitate high maneuverability of the vehicle 100, especially in tight spaces where a small turning radius is beneficial. Similar motions may be achieved with the second set of wheels 112. As noted above, rotation and steering of the first set of wheels 108 and second set of wheels 112 may be coordinated, but each wheel 140 in the set of wheels 108, 112 may be independently driven.

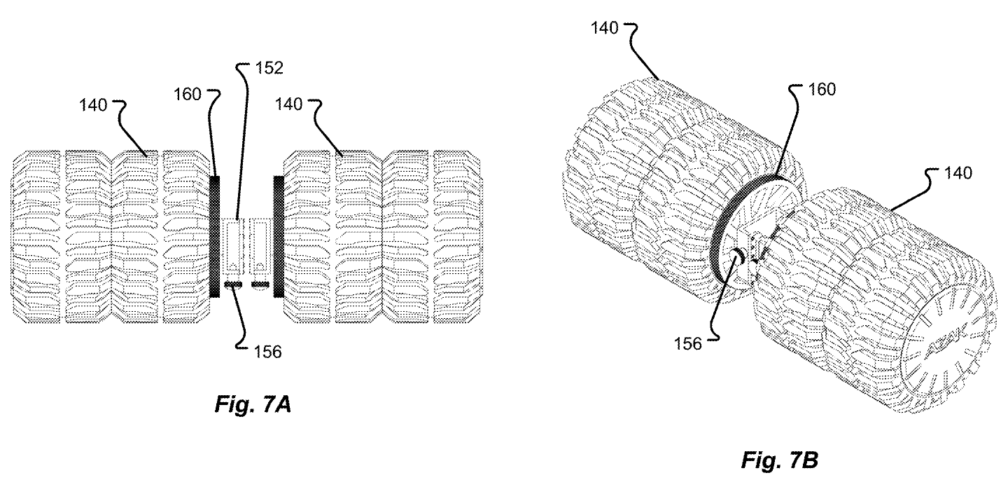

Referring now to FIGS. 7A – 8B, additional details of the wheels 140 will be described in accordance with at least some embodiments of the present disclosure. One or more wheels 140 provided on the vehicle 100 may be configured as shown. The wheels 140 may include a mounting interface 152, which may provide mechanical and/or electrical mechanisms for attaching the wheel 140 to a rotatable mount (e.g., the first rotatable mount 132 or second rotatable mount 136). In some embodiments, the mounting interface 152 may include one or more physical limiters 156. The physical limiters 156 may be configured to interface with a post or stop on the frame 104 that contacts the physical limiters 156. In some embodiments, the physical limiters 156 may include a physical post or the like along with a bumper that physically contacts a post of stopper of the frame 104. The physical limiter 156 may help to ensure that the wheel 140 or set of wheels 108, 112, does not rotate about the steering axis 120, 128 more than a predetermined amount.

The mounting interface 152 may be configured to physically attach to the rotatable mount 132, 136. The wheels 140 may also include bearings 160 that facilitate rotation around the rotational axes 140, 148. In some embodiments, the bearings 160 may also include gears or the like that translate rotational motion of a motor into rotational motion of the wheels 140. The bearings 160 may also support the physical weight of the frame 104 and loads placed upon the frame, while still maintaining rotational movement of the wheels around the rotational axes 144, 148.

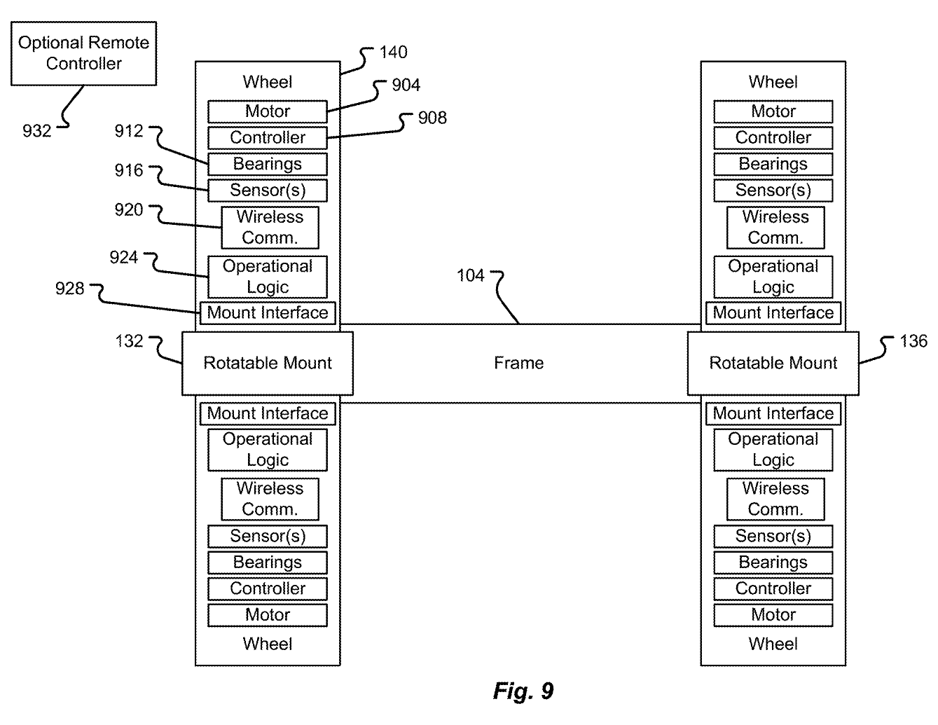

With reference now to FIG. 9, additional details of the components of the wheels 140 will be described in accordance with at least some embodiments of the present disclosure. One, some, or all of the wheels 140 may include a motor 904, a controller 908, bearings 912, sensor(s) 916, a wireless communication module 920, operational logic 924, and a mount interface 928.

The mount interface 928 may be similar or identical to the mount interface 152. The mount interface 928 may provide a mechanical connection between the rotatable mount 132, 136 and the wheel 140. In some embodiments, the mount interface 928 may include bolts, fasteners, or the like that physically attach the wheel 140 to the rotatable mount 132, 136. Whereas the rotatable mounts 132, 136 are configured to rotate about the steering axes 120, 128, the mount interface 928 may be configured to attach to the rotatable mounts 132, 136 and facilitate rotation of the wheels 140 around the rotational axes 144, 148. The mount interface 928 may include the bearings 912, which may be similar or identical to bearings 160.

The motor 904 may include any device or collection of devices that translate energy into motion. In some embodiments, the motor 904 may generate rotational motion of one or more gears, that is converted into rotational motion of the wheel 140. The motor 904 may include, without limitation, a servo motor, a direct drive motor, a linear motor, an AC motor, a DC motor, a stepper motor, or the like. The motor 904 may be operated by the controller 908, which provides input signals to the motor 904. The controller 908 may be responsive to control signals received from a remote controller 932 and/or control signals received from internal operational logic 924.

In some embodiments, the operational logic 924 may include instructions and/or machine learning models that facilitate autonomous operation of the vehicle 100. The operational logic 924 may alternatively or additionally include logic that facilitates coordination of the wheel’s 140 operation with operation of other wheels 140 on the vehicle 100. For example, all of the wheels 140 may include instructions from the remote controller 932 to make a turn in a particular direction. The operational logic 924 of each wheel 140 may convert the instructions received from the remote controller 932 into specific motor control instructions for the appropriate wheel 140 (i.e., some wheels 140 may rotate in one direction while other wheels may rotate in another direction). Alternatively or additionally, the operational logic 924 of each wheel 140 may communicate with operational logic 924 of other wheels 140 to coordinate motor 904 motion and cohesively control the vehicle 100. As mentioned above, the operational logic 924 may include machine learning models that facilitate autonomous or semi-autonomous operation of the vehicle 100. Inputs for the operational logic 924 may include inputs received from one or more sensors 916 on the wheels 140. Other inputs for the operational logic 924 may include inputs received from sensors on the frame 104. Examples of the sensors 916 that may be included in the wheels 140 and/or frame 104 are proximity sensors, motion sensors, accelerometers, force sensors, LIDAR sensors, image sensors, speed sensors, rotation sensors, etc.

It should be appreciated that the operational logic 924 may be incorporated into the controller 908 of the wheels 140. While depicted as part of the wheels 140, it should also be appreciated that the operational logic 924 and/or controller 908 functions may be provided by a component or collection of components that are mounted on the frame 104. For instance, motor control signals may be initiated by or coordinated with a controller 908 and/or operational logic 924 that is executed by a processor, CPU, GPU, etc., that is mounted on the frame 104. Said another way, the controller(s) 908 of the motors 904 may be contained within the wheels 140 or external to the wheels 140 (e.g., on the frame 104).

Regardless of its position or distribution across the vehicle 100, the controller 908 may utilize the operational logic 924 to process inputs from the sensor(s) 916 to determine which control signals should be generated and sent to the motor 904. As mentioned above, the controller 908 may respond to control signals received from a remote controller 932, which may be received via a wireless communication module 920. As an example, the wireless communication module 920 may include an antenna and corresponding driver that converts wireless controls signals received from the remote controller 932 into control signals that are provided to the controller 908. The controller 908 may then generate control signals for the motor 904, which will cause the motor 904 to rotate in a particular direction at a particular speed. Alternatively or additionally, the wireless communication modules 920 of each wheel 140 may enable wireless communications between wheels 140. For instance, one wheel 140 may include a primary controller 908 that communicates control signals to other wheels 140 via the wireless communication modules 920. In this way, operation of the wheels 140 may be coordinated even though each wheel 140 includes its own controller 908 and motor 904. As can be appreciated the controller 908 may be implemented using a microprocessor and computer memory. Alternatively or additionally, the controller 908 may be implemented using a Field Programmable Gate Array (FPGA), an Application Specific Integrated Circuit (ASIC), or the like.

Referring now to Fis. 10A – 10G, additional details of another example of a vehicle 100 will be described in accordance with at least some embodiments of the present disclosure. The vehicle 100 is shown to include a frame 104 onto which a first wheel 140a, a second wheel 140b, a third wheel 140c, and a fourth wheel 140d are connected. The first and second wheels 140a, 140b may be collectively referred to as a first set of wheels (e.g., front wheels). The third and fourth wheels 140c, 140d may be collectively referred to as a second set of wheels (e.g., back wheels). The first set of wheels 140a, 140b and second set of wheels 140c, 140d may be steered independently and/or in a coordinated fashion to successfully maneuver the vehicle 100.

In some embodiments, the first wheel 140a may be turnable or rotatable about a first rotational axis 1004a. The second wheel 140b may be turnable or rotatable about a second rotational axis 1004b. The third wheel 140c may be turnable or rotatable about a third rotational axis 1004c. The fourth wheel 140d may be turnable or rotatable about a fourth rotational axis 1004d.

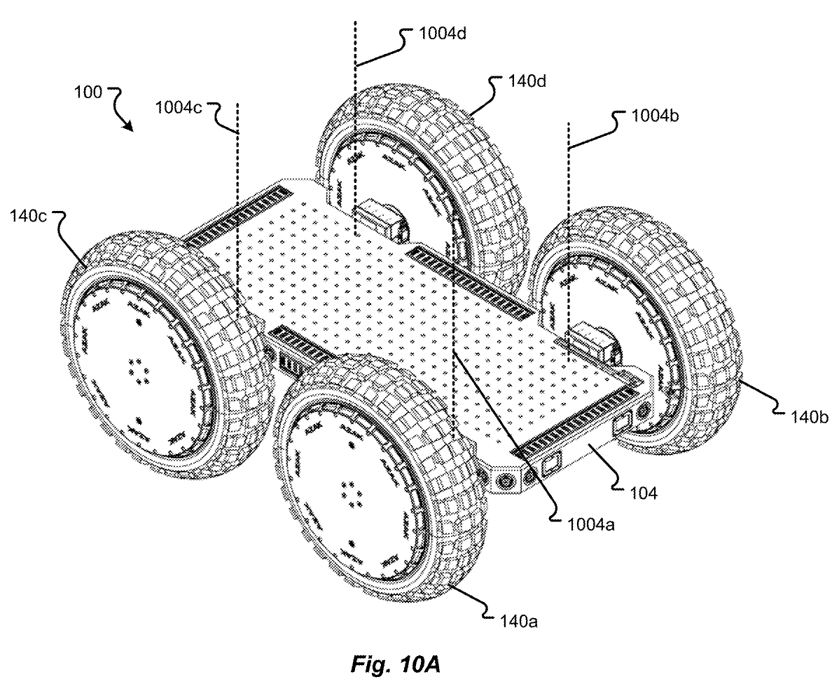

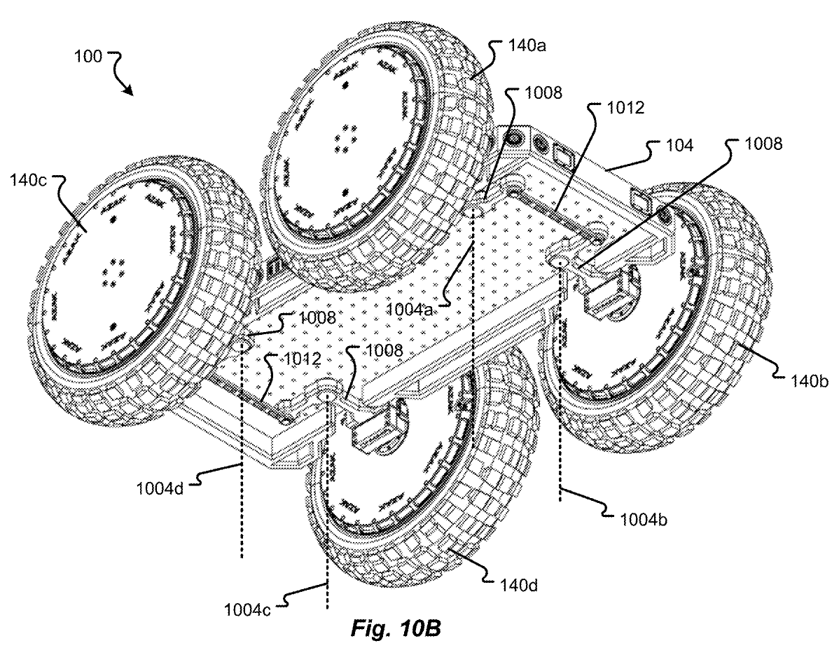

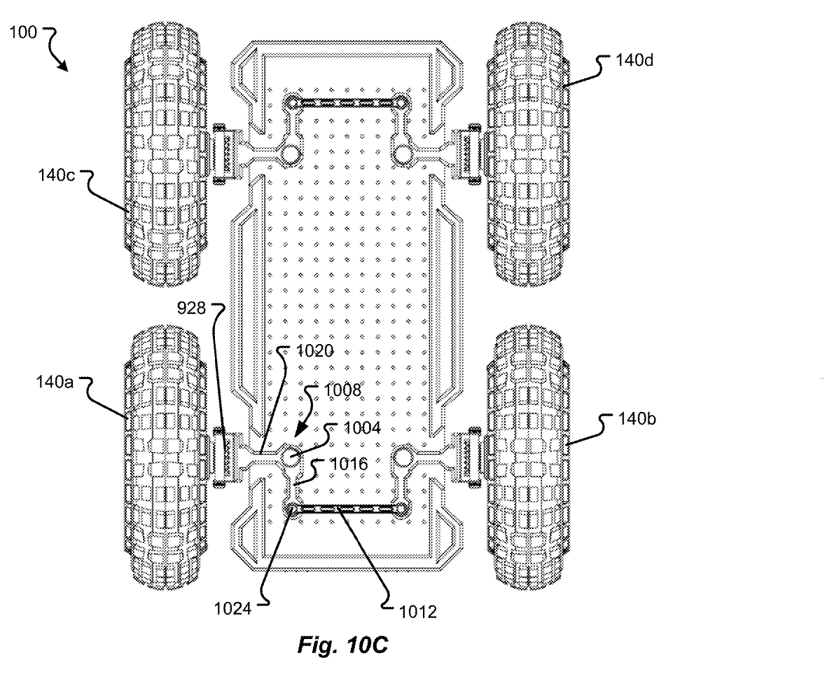

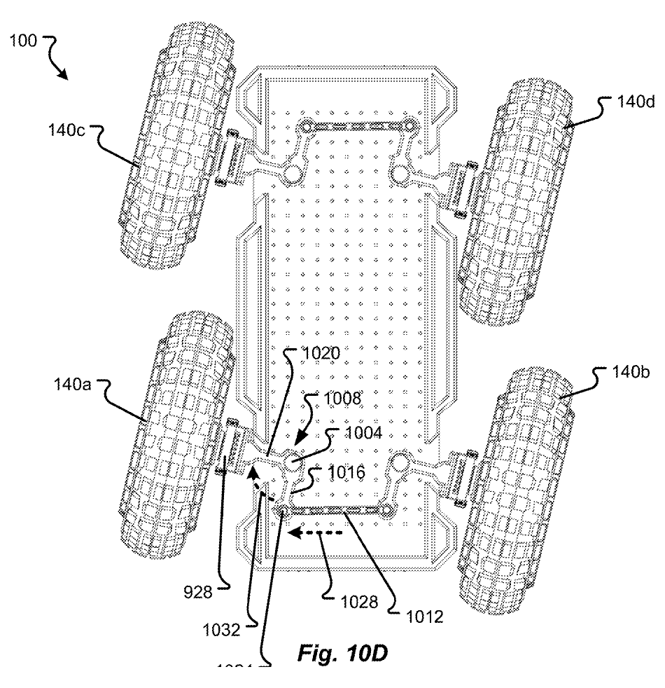

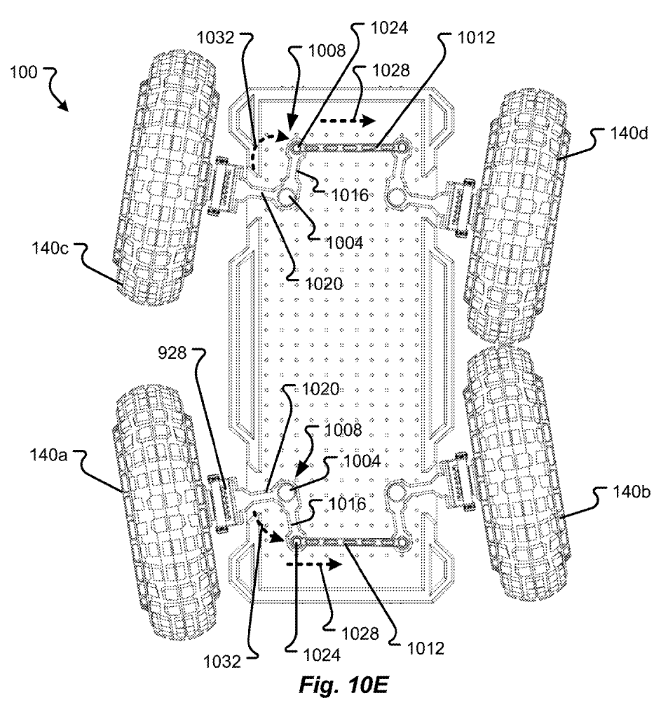

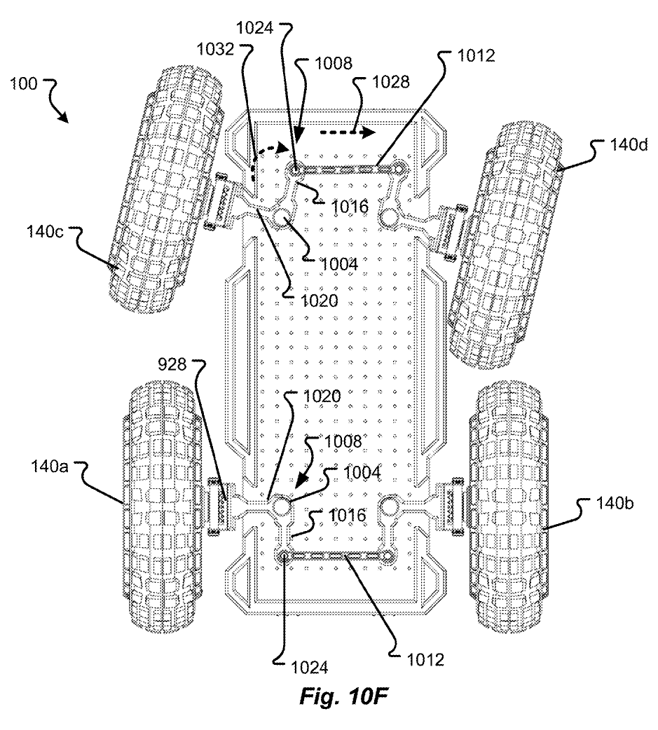

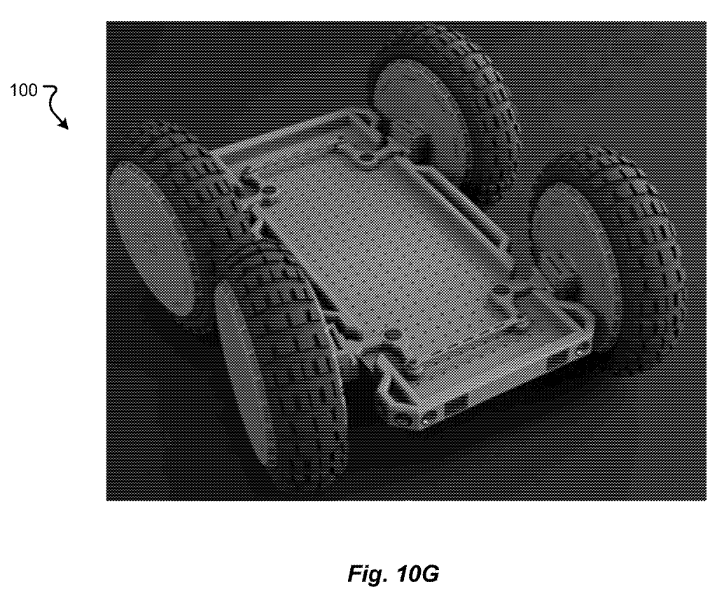

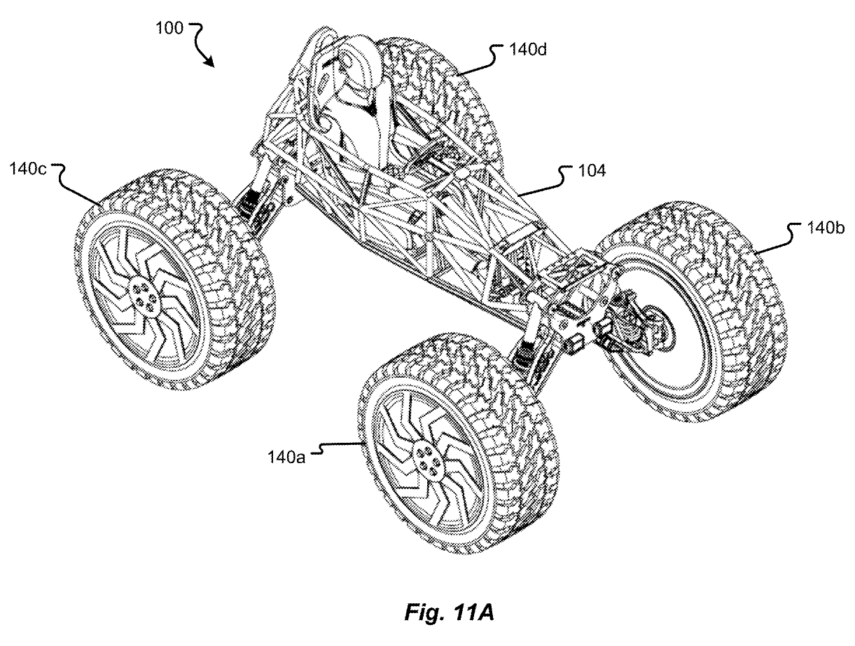

As can be seen in FIG. 10B, each rotational axis 1004a, 1004b, 1004c, 1004d may pass through a separate wheel pivot point of a wheel coupling 1008. In some embodiments, the first rotational axis 1004a may pass through a pivot point of a wheel coupling 1008 for the first wheel 140a, the second rotational axis 1004b may pass through a pivot point of a wheel coupling 1008 for the second wheel 140b, the third rotational axis 1004c may pass through a pivot point of a wheel coupling 1008 for the third wheel 140c, and the fourth rotational axis 1004d may pass through a pivot point of a wheel coupling 1008 for the fourth wheel 140d. Because the pivot points for each wheel 140a, 140b, 140c, 140d are located at different locations on the frame 104, the first rotational axis 1004a, the second rotational axis 1004b, the third rotational axis 1004c, and the fourth rotational axis 1004d are substantially parallel with one another.

In some embodiments, each wheel 140a, 140b, 140c, 140d is connected to the frame 104 with a wheel coupling 1008. The wheel coupling 1008 may include a first arm 1020 providing a connection with a mount interface 928 and a second arm 1016 coupled with the first arm 1020 through a pivot point. The pivot point connecting the first arm 1020 with the second arm 1016 may comprise a ball and socket assembly that enables the wheel coupling 1008 to pivot about the corresponding rotational axis 1004 in addition to enabling the first arm 1020 to pivot vertically (e.g., to support a limited amount of vertical wheel 140 movement). Alternatively, the pivot point connecting the first arm 1020 with the second arm 1016 may comprise a shaft assembly that restricts the motion of the wheel coupling 1008 to rotational motion around the rotational axis 1004.

The wheel coupling for the first wheel 140a (e.g., a first wheel coupling 1008) may be connected with the wheel coupling for the second wheel 140b (e.g., a second wheel coupling 1008) by a translational member 1012 (e.g., a first translational member 1012). Thus, the first set of wheels 140a, 140b may include a pair of wheel couplings 1008 and a translational member 1012 connecting the first wheel coupling 1008 with the second wheel coupling 1008. In some embodiments, the first translational member 1012 may help synchronize the rotational motion of the first wheel 140a with the second wheel 140b. As can be seen in FIGS. 10D and 10E, lateral motion 1028 of the first translational member 1012 may, in some embodiments, correlate to rotational motion 1032 of both wheels 140a, 140b in the first set of wheels. In some embodiments, the first translational member 1012 may be connected to the second arm 1016 of each wheel coupling 1008, which is offset from the pivot point of the wheel coupling 1008. Such a configuration helps to synchronize the rotational motion of the of the first wheel 140a and the second wheel 140b.

The wheel coupling for the third wheel 140c (e.g., a third wheel coupling 1008) may be connected with the wheel coupling for the fourth wheel 140d (e.g., a fourth wheel coupling 1008) by a translational member 1012 (e.g., a second translational member 1012). Thus, the second set of wheels 140c, 140d may include a pair of wheel couplings 1008 and a translational member 1012 connecting the third wheel coupling 1008 with the fourth wheel coupling 1008. In some embodiments, the second translational member 1012 may help synchronize the rotational motion of the third wheel 140c with the fourth wheel 140d. As can be seen in FIGS. 10D, 10E, and 10F, lateral motion 1028 of the second translational member 1012 may, in some embodiments, correlate to rotational motion 1032 of both wheels 140c, 140d in the second set of wheels. In some embodiments, the second translational member 1012 may be connected to the second arm 1016 of each wheel coupling 1008, which is offset from the pivot point of the wheel coupling 1008. Such a configuration helps to synchronize the rotational motion of the of the third wheel 140c and the fourth wheel 140d.

In some embodiments, the translational member 1012 is connected to each wheel coupling 1008 at a second pivot point 1024. The second pivot point 1024 may be offset from the rotational axis 1008 of the wheel coupling 1008, which helps to coordinate the lateral motion 1020 with rotational motion 1032 of each wheel coupling 1008.

It should be appreciated that each coupling 1008 may be connected directly to the frame 104 with a joint the facilitates at least the rotational motion 1032, but which may also facilitate vertical motion (e.g., a suspension system that enables vertical motion of a wheel 140 relative to the frame 104). As noted above, the joint connecting the wheel coupling 1008 to the frame 104 may include a ball and socket joint or a shaft. The joint may also, alternatively, include a suspension system that enables the wheel coupling 1008 to move vertically relative to the frame 104 (e.g., to absorb impacts on the wheels 140).

The connection between the mount interface 928 and the wheel coupling 1008 may be substantially fixed, meaning that motion of the wheel (e.g., turning of the wheel 140) is directly translated into a same motion at the first arm 1020. Because each wheel 140 may include its own motor 904, the wheel 140 may have its speed adjusted to create a turning motion (e.g., rotational motion 1032) for the wheel 140. Also, because a wheel is connected to another wheel though the translational member 1012 as well as a pair of wheel couplings 1008, the set of wheels can be steered by adjusting the speed with which each wheel 140 in the pair of wheels is spinning. For example, the first set of wheels may be turned by having the first wheel 140a spin at a different rate or speed than the second wheel 140b. This difference in speed of wheel rotation can create rotational motion 1032 of both wheels, that is synchronized/controlled by the translational member 1012.

In the example of FIG. 10D, the second wheel 140b may be driven at a faster speed than the first wheel 140a, causing the first set of wheels to turn left (e.g., rotate such that the second wheel 140b is turning inwardly toward the frame 104 while the first wheel 140a is turning outwardly away from the frame 104). In the example of FIG. 10E, the first wheel 140a may be driven at a faster speed than the second wheel 140b, causing the first set of wheels to turn right (e.g., to rotate such that the first wheel 140a is turning inwardly toward the frame 104 while the second wheel 140b is turning outwardly away from the frame 104). In both steering maneuvers, the relative motion of the wheels 140a, 140b is controlled by their respective motors 904 and controllers 908, but limited by the translational member 1012.

A similar approach can be taken with respect to the second set of wheels (e.g., the third wheel 140c and fourth wheel 140d). More specifically, as can be seen in FIGS. 10D, 10E, and 10F, the second set of wheels can be steered and the relative motion of the third wheel 140c can be limited with respect to the fourth wheel 140d through the mechanical interactions between the translational member 1012 and wheel couplings 1008. In the example of FIG. 10E, the second set of wheels are turned such that the third wheel 140c is turned outwardly away from the frame 104 and the fourth wheel 140d is turned inwardly toward the frame 104. This steering can be achieved by driving the third wheel 140c at a faster rate than the fourth wheel 140d.

It should be appreciated that the independent control of the first set of wheels and the second set of wheels can help the vehicle 100 turn on a tighter radius (e.g., as shown in FIG. 10E) or crab walk (e.g., as shown in FIG. 10D). It may also be possible to have one set of wheels not turn (e.g., by having both wheels in the set of wheels driven at the same speed) while another set of wheels is turned (e.g., by having one wheel in the set of wheels driven at a different speed from the other wheel in the same set of wheels). Such a steering configuration is shown in FIG. 10F.

Steering the vehicle 100 by adjusting the relative speed of both wheels in a set of wheels may include a number of differential speed adjustments, depending upon the steering maneuver. For instance, a first speed differential between the first wheel 140a and second wheel 140b may cause the first set of wheels to initially turn (e.g., rotate) a first amount. Then, a second speed differential between the first wheel 140a and second wheel 140b may be used to control the turning of the first set of wheels as the vehicle 100 drives or steers through a corner. In other words, the speed differential between the first wheel 140a and the second wheel 140b may be changed from the time where the first set of wheels is initially turned and the time where the first set of wheels is maintaining a turn. As an example, a larger speed differential may be used to initiate the turning of the first set of wheels, then a smaller speed differential may be used to maintain the turning of the first set of wheels.

This type of steering configuration can be achieved by turning one set of wheels while not turning the other set of wheels. It may be possible to steer only the front set of wheels (e.g., the first set of wheels) and not the rear set of wheels (e.g., the second set of wheels). Alternatively, it may be possible to steer only the back set of wheels (e.g., the second set of wheels) and not the front set of wheels (e.g., the first set of wheels). The coordinated steering of the vehicle 100 through manipulation of both sets of wheels can be achieved using the wheel controllers 908 of each wheel 140. The controllers 908 can be coordinated with a remote controller 932 or by programmable logic 924 at each wheel 140. In other words, control of the vehicle 100 can be achieved through manual control of the remote controller 932 and/or by programmed logic in the vehicle 100. Alternatively or additionally, Artificial Intelligence (AI) control logic can be used to coordinate the controller 908 of each wheel 140 and to ensure that the sets of wheels operate in a coordinated fashion to maneuver the vehicle 100 in a desired direction, at a desired speed, and without damaging the vehicle 100 or components thereof.

It should be appreciated that the rotational motion 1032 of the first set of wheels can be limited by a mechanical limiter or by controlling the relative drive speed of the first wheel 140a and second wheel 140b. In other words, a mechanical stop may be provided to limit rotational motion of the first and second wheel couplings 1008, thereby preventing each wheel in the first set of wheels from hitting the frame 104. Another approach to limit such impacts would be to synchronize/limit the different drive speeds that can be applied to the first wheel 140a and second wheel 140b. Such drive speed differentials can be used to create steering motion of the first set of wheels (e.g., to start cornering) as well as support steering through corners.

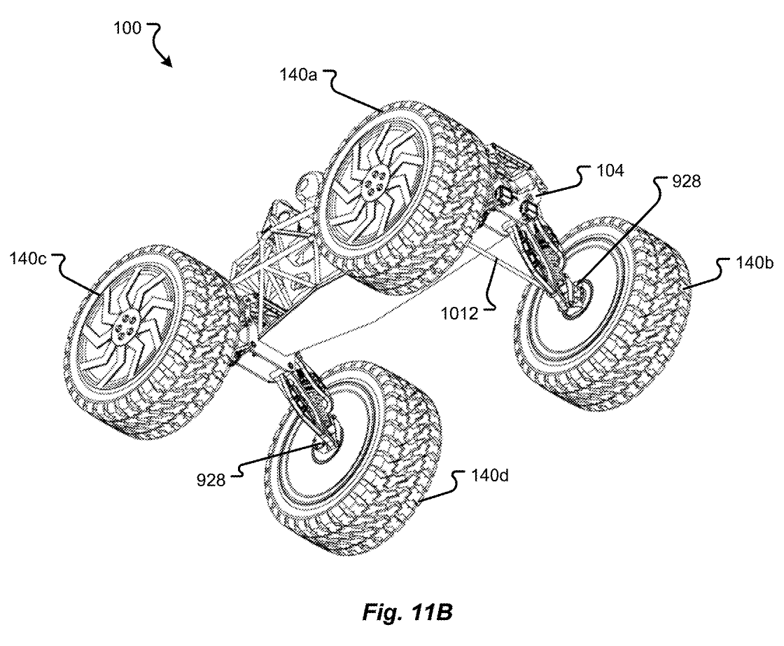

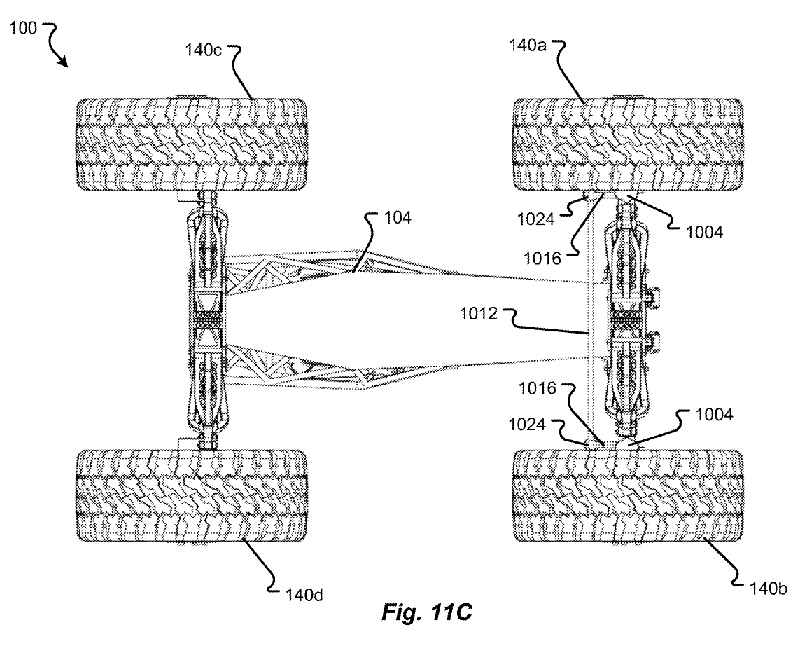

Referring now to FIGS. 11A – 11C, additional details of another example of a vehicle 100 will be described in accordance with at least some embodiments of the present disclosure. The vehicle 100 of FIGS. 11A – 11C may include many of the same or similar components as the vehicle of FIGS. 10A – 10G. For example, the vehicle 100 is shown to include a frame 104 onto which a first wheel 140a, a second wheel 140b, a third wheel 140c, and a fourth wheel 140d are connected. The first and second wheels 140a, 140b may be collectively referred to as a first set of wheels (e.g., front wheels). The third and fourth wheels 140c,140d may be collectively referred to as a second set of wheels (e.g., back wheels). The first set of wheels 140a, 140b and second set of wheels 140c, 140d may be steered independently and/or in a coordinated fashion to successfully maneuver the vehicle 100.

Each wheel 140a, 140b, 140c, 140d may have its own independent rotational axis 1004 in some embodiments. In other embodiments, the first wheel 140a and the second wheel 140b may have their own rotational axes 1004 whereas the third wheel 140c and fourth wheel 140d may not be rotatable, meaning that steering of the vehicle 100 is achieved through rotation of the first wheel 140a and the second wheel 140b only. The first wheel 140a and second wheel 140b may be coupled to one another via a translational member 1012. The translational member 1012 may be offset from the rotational axis 1004 of the first wheel 140a and the rotational axis 1004 of the second wheel 140b as shown in FIG. 11C.

In some embodiments, the first wheel 140a and the second wheel 140b each have mechanical component(s) at their associated rotational axis 1004 that are coupled with the translational member 1012 via corresponding arms 1016. One end of an arm 1016 is coupled with mechanical component(s) at the rotational axis 1004 and the other end of the arm 1016 is coupled with an end of the translational member 1012. In such a configuration, rotational motion of one wheel (e.g., the first wheel 140a) is translated into rotational motion of the other wheel (e.g., the second wheel 140b) via the translational member 1012, in a similar manner to the one depicted and described in connection with FIGS. 10A – 10G.

The vehicle 100 is further shown to include suspension components that enable each wheel 140a, 140b, 140c, 140d to move independently vertically with respect to the frame 104.

The suspension components may be coupled to each wheel via an appropriate wheel coupling 1008 and may include shocks, suspension, springs, pistons, hydraulics, pneumatics, or the like. The translational member 1012 may be connected between the wheels (e.g., between the first wheel 140a and the second wheel 140b) with a ball-and-socket coupling to enable independent vertical motion of the first wheel 140a and the second wheel 140b.

Specific details were given in the description to provide a thorough understanding of the embodiments. However, it will be understood by one of ordinary skill in the art that the embodiments may be practiced without these specific details. Additionally, the Figures do not depict well-known features that may be needed to create a working vehicle so as not to obscure the embodiments in unnecessary detail.

What is claimed is:

1. A vehicle, comprising:
a frame;
a first set of wheels comprising a first wheel and a second wheel, wherein the first wheel and the second wheel are rotatable relative to the frame around a first rotational axis and a second rotational axis, respectively, and wherein the first wheel and the second wheel are coupled with a first translational member via a first coupling and a second coupling, respectively, that translates lateral motion of the first translational member into rotational motion of the first wheel and second wheel, respectively; and
a second set of wheels comprising a third wheel and a fourth wheel.

2. The vehicle of claim 1, wherein the third wheel and the fourth wheel are rotatable relative to the frame around a third rotational axis and a fourth rotational axis, respectively, and wherein the third wheel and the fourth wheel are coupled with a second translational member via a third coupling and a second coupling, respectively, that translates lateral motion of the second translational member into rotational motion of the third wheel and fourth wheel, respectively.

3. The vehicle of claim 2, wherein the first rotational axis, the second rotational axis, the third rotational axis, and the fourth rotational axis are substantially parallel with one another.

4. The vehicle of claim 2, wherein each of the first coupling, second coupling, third coupling, and fourth coupling comprise:
a first arm providing a connection with a mount interface; and
a second arm coupled with the first arm through a first pivot point, wherein the second arm comprises a translational member coupling that coverts lateral motion into rotational motion of the first arm and second arm.

5. The vehicle of claim 2, wherein the first set of wheels are steerable independent of the second set of wheels.

6. The vehicle of claim 2, further comprising:
a first motor controller for the first wheel;
a second motor controller for the second wheel;
a third motor controller for the third wheel; and
a fourth motor controller for the fourth wheel.

7. The vehicle of claim 6, wherein the first motor controller, the second motor controller, the third motor controller, and the fourth motor controller are incorporated into the first wheel, the second wheel, the third wheel, and the fourth wheel, respectively.

8. The vehicle of claim 6, wherein the first motor controller, the second motor controller, the third motor controller, and the fourth motor controller enable skid steering of the vehicle.

9. The vehicle of claim 6, wherein the first motor controller, the second motor controller, the third motor controller, and the fourth motor controller operate autonomously.

10. The vehicle of claim 6, wherein the first motor controller, the second motor controller, the third motor controller, and the fourth motor controller coordinate with one another and operate based on control signals received from a remote controller.

11. The vehicle of claim 10, wherein the remote controller is operated manually.

12. The vehicle of claim 6, wherein at least of the first motor controller, the second motor controller, the third motor controller, and the fourth motor controller comprise Artificial Intelligence (AI) to support coordination with at least one other motor controller.

13. The vehicle of claim 1, further comprising:
a limiter that prohibits the first set of wheels from pivoting more than a predetermined amount.

14. The vehicle of claim 13, wherein the limiter comprises a physical stop.

15. The vehicle of claim 13, wherein the limiter comprises a control limiter that prevents a drive speed of the first wheel and a drive speed of the second wheel from differing by more than a predetermined amount.

16. The vehicle of claim 13, wherein the limiter ensures that the first set of wheels does not collide with the second set of wheels.

17. The vehicle of claim 1, wherein the first set of wheels are connected to the frame with a suspension system.

18. The vehicle of claim 17, wherein the suspension system comprises a first suspension for the first coupling and a second suspension for the second coupling.

19. The vehicle of claim 1, wherein the first set of wheels are steered by controlling a difference between a speed of rotation of the first wheel and a speed of rotation of the second wheel.

20. The vehicle of claim 19, wherein a first difference between the speed of rotation of the first wheel and the speed of rotation of the second wheel is used to initially turn the first set of wheels and wherein a second difference between the speed of rotation of the first wheel and the speed of rotation of the second wheel is used to maintain the first set of wheels in a position while cornering.

21. The vehicle of claim 20, wherein the first difference is greater than the second difference.

22. The vehicle of claim 1, further comprising:
a first motor controller for the first wheel;
a second motor controller for the second wheel.

23. A vehicle, comprising:
a frame; and
a first set of wheels comprising a first wheel and a second wheel, wherein the first wheel and the second wheel are rotatable relative to the frame around a first rotational axis and a second rotational axis, respectively, and wherein the first wheel and the second wheel are coupled with a first translational member via a first coupling and a second coupling, respectively, that translates lateral motion of the first translational member into rotational motion of the first wheel and second wheel, respectively.

24. The vehicle of claim 23, wherein the first coupling comprises a ball and socket at the first rotational axis.

25. The vehicle of claim 23, wherein the first coupling comprises a shaft at the first rotational axis.
